(19) United States
(12) Patent Application Publication
(10) Pub. No.: US 2008/0312797 A1
(43) Pub. Date: Dec. 18, 2008

(54) Seat control apparatus

(75) Inventor: Satoshi Takehisa, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/155,882

(22) Filed: Jun. 11, 2008

(30) Foreign Application Priority Data
Jun. 18, 2007 (JP) 2007-160594

(51) Int. Cl. B60N 2/01; G05D 3/00

(52) U.S. Cl. 701/49

(57) ABSTRACT

An ECU in a third seat equipped vehicle receives a reservation signal from a portable device, and answers back to the portable device with a vehicle condition signal that indicates that the second row and the third row of seats are automatically movable. When a door of the vehicle is unlocked, the ECU outputs a drive signal that indicates opening of a power slide door and the ECU also outputs a voice for warning the opening of the power slide door. When the second row and the third row of seats are movable, the ECU moves the second row of seats for allowing the user to have an access to the third row of seats, and also puts the third row of seats in a suitable condition for sitting by the user.

### CROSS REFERENCE TO RELATED APPLICATION

The present application is based on and claims the benefit of priority of Japanese Patent Application No. 2007-160594 filed on Jun. 18, 2007, the disclosure of which is incorporated herein by reference.

### FIELD OF THE INVENTION

The present disclosure generally relates to a seat control apparatus for use in a vehicle.

### BACKGROUND INFORMATION

Conventionally, a user of a vehicle that has the third seat (i.e., a third row of seats, or a seat that comes third from a front row of seat when a vehicle has at least three rows of seats) has an access to the third seat only after folding the back of the second seat, or after sliding the second seat in a frontward direction. If an electric seat slider apparatus for sliding the seat by operating a motor is equipped in the vehicle as disclosed in Japanese patent document JP-A-H08-156658, the seat can be slid forward by an operation of a switch of the slider apparatus.

However, in the disclosure of the above patent document, the seat has to be explicitly instructed to be slid forward by the user when the user controls the slider apparatus. Further, if the user is not familiar with a position of the switch for controlling the slider apparatus, or, in other words, if the user is not familiar with an operation of how to slide the seat, the seat may not be easily slid forward.

### SUMMARY OF THE INVENTION

In view of the above and other problems, the present invention provides a seat control apparatus that enables an easy access to the third seat when the vehicle has at least three rows of seats.

The seat control apparatus of the present invention includes: a controller on a vehicle that has three rows of seats; and an instruction unit capable of communicating with the controller. Further the instruction unit includes: a built-in communication unit capable of communicating with the controller on the vehicle; and an operation unit capable of being operated by a user who instructs a transmission of a reservation signal that is transmitted from an outside of the vehicle through the built-in communication unit to arrange the seats of the vehicle in a predetermined setting, and the controller includes: a vehicle-side communication unit capable of communicating with the built-in communication unit in the instruction unit; a lock condition detection unit capable of detecting a lock condition of a door of the vehicle; a driving unit capable of driving a second row and a third row of the seats of the vehicle; and a control unit capable of controlling the driving unit to arrange the second row and the third row of the seats in the predetermined setting when a detection result of the door lock condition detected by the lock condition detection unit indicates that the door is being unlocked after receiving the reservation signal by the vehicle-side communication unit.

As described above, the third seat becomes easily accessible for boarding and/or sitting when, prior to unlocking the door, a reservation signal for an automatic setting of the second seat and the third seat in a predetermined condition only by unlocking the door is transmitted from an outside of the vehicle.

### BRIEF DESCRIPTION OF THE DRAWINGS

Other objects, features and advantages of the present invention will become more apparent from the following detailed description made with reference to the accompanying drawings, in which:

FIG. 1 shows a block diagram a vehicle seat control apparatus in an embodiment of the present invention; and

FIG. 2 shows a flowchart of an operation of the vehicle seat control apparatus in the embodiment.

### DETAILED DESCRIPTION

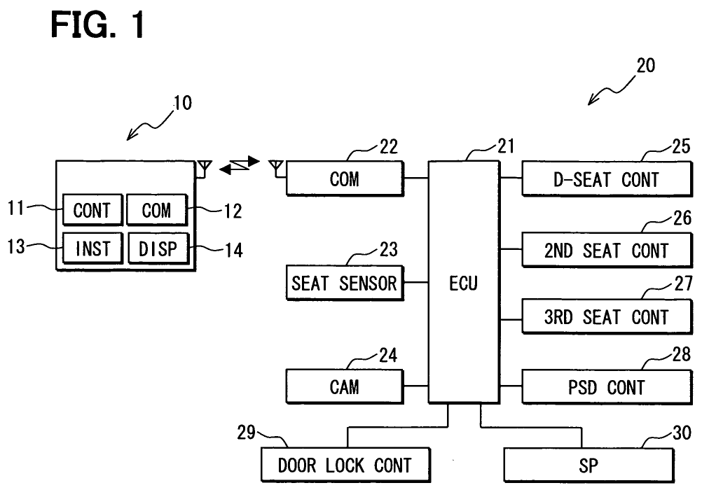

An embodiment of the present invention is explained as follows based on the figure. FIG. 1 is a cross section showing the outline configuration of a vehicle seat control apparatus in an embodiment of the present invention.

The vehicle seat control apparatus in the present embodiment has a portable unit 10 which is wirelessly communicable and a vehicle side control unit 20 as shown in FIG. 1.

The portable unit 10 is equivalent to an instruction unit of the present invention, and includes a control unit 11 having a CPU, a memory and the like for providing a general control of the portable unit 10, a portable communication unit 12 (simply mentioned as a communications unit in the drawing) performing wireless communication to/from a vehicle side communication unit 22 (also simply mentioned as a communications unit in the drawing) in a vehicle side control unit 20, an instruction unit 13 which is operated by a user and is used to instruct a transmission of a reservation signal, and a the display unit 14 including liquid crystal displays displaying desired information.

When the user is going to take the third seat (e.g., the third row of seat in a minivan or the like), the back of the second seat is knocked over forward, or the second seat is slid forward, to make the third seat being accessible. Further, the third seat has to be returned to a sitting position from a retracted position if the third seat is put in the retracted position.

The reservation signal is a signal that is used to send an instruction, to an ECU 21 of the vehicle side control unit 20, that moves the second seat and the third seat to a predetermined position when the user is going to take the third seat. In other words, the reservation signal moves the second seat so that the user can go through toward the third seat, and also moves the third seat so that the third seat is available for the user. In addition, the operation of the vehicle side control unit 20 based on the reservation signal is described later in detail.

In addition, though, in the present embodiment, the portable unit 10 is adopted as an example of the instruction unit of the present invention, various modifications are allowable. For example, the purpose of the present invention can be achieved when the instruction unit is implemented as a communication device such as a personal computer, a mobile telephone, a PDA (Personal Digital Assistant), a vehicle key (a smart key or the like) that can communicate with the vehicle side communications unit 22 in the vehicle side control unit 20 wirelessly from an outside of the vehicle. In addition, the instruction unit such as the portable unit 10 and the vehicle side communications unit 22 may wirelessly communicate through wireless communications such as infrared rays, communication through the Internet network or the like.

The vehicle side control unit 20 is disposed on a vehicle having three rows of seat, and includes the ECU 21, the vehicle side communications unit 22, a seat sensor 23, a camera 24, a D-seat seat control unit 25, a second seat control unit 26, a third seat control unit 27, a PSD control unit 28, a door lock control unit 29, a speaker 30 (each of which are explained in the following).

The ECU (Electronic Control Unit) 21 performs general control of the vehicle side control unit 20 that includes a CPU, a memory and the like. For example, the ECU 21 controls the second seat control unit 26 and the third seat control unit 27 based on a reservation signal and the condition of the door lock of the vehicle transmitted from the portable communication unit 12.

The vehicle side communications unit 22 is equivalent to a vehicle-side communication unit in the present invention, and performs wireless communication with the portable communication unit 12, and outputs a received signal (a reservation signal) to the ECU 21. The seat sensor 23 includes a pressure sensor disposed in the second seat and the third seat, and detects the sitting condition of the second and third seat to output the detection result to the ECU 21. The camera 24 is disposed in a vehicle compartment, and captures an image around the second and third seat to output the image to the ECU 21.

The D-seat (a driver's seat) seat control unit 25 has a motor, and drives the driver's seat based on a driving signal from the ECU 21. For example, the D-seat seat control unit 25 moves the D-seat in the front and back direction relative to the progress direction of the vehicle.

The second seat control unit 26 is equivalent to the driving unit in the present invention, and includes motors and the like for driving the second seat of the vehicle based on a driving signal from the ECU 21. For example, the back of the second seat is folded, and/or the second seat is slid forward based on the signal. In addition, the folded back of the second seat is restored to an upright position, or the slid forward second seat is moved backward for the sitting of the user, based on the driving signal. Further, the positions such as the folded position or the upright position of the seat back of the second seat, the slid forward position and the sitting position of the second seat are stored in the second seat control unit 26, and the second seat of the vehicle is controlled based on the driving signal from the ECU 21 with reference to the stored positions.

The third seat control unit 27 is equivalent to the driving unit in the present invention, and includes motors and the like for driving the third seat of the vehicle based on a driving signal from the ECU 21. For example, the back of the third seat is folded and the third seat is retracted to the retracted position of an inside of the floor so that a floor is in a flat condition, under control of the third seat control unit 27. In addition, the third seat in the retracted position is restored to be in the sitting position for the user to take the third seat, and the back of the third seat is put in an upright condition. Further, the positions such as the folded position or the upright position of the seat back of the third seat, the retracted position and the sitting position of the third seat are stored in the third seat control unit 27, and the third seat of the vehicle is controlled based on the driving signal from the ECU 21 with reference to the stored positions.

The PSD (Power Slide Door) control unit 28 has motors, and drives a PSD (Power Slide Door, in this case, a rear door) disposed at a position corresponding to the second and third seat based on a driving signal from the ECU 21.

The door lock control unit 29 is disposed corresponding to each of the doors of the vehicle, and includes a door lock motor, a door lock detection unit and the like. Further, the door lock control unit 29 controls the locking and unlocking of each of the doors based on a control signal sent from a body ECU (not shown) for driving a built-in door lock motor in a normal and a reverse direction. In addition, the door lock control unit 29 detects a lock and an unlock condition of the doors based on a control signal from the body ECU by a built-in door lock detection unit. The speaker 30 provides voice output based on an instruction signal from the ECU 21.

In addition, the body ECU performs bidirectional cryptography communication with the smart key which is held by the user, and determines whether the identification code that is stored in the body ECU and the identification code transmitted by the smart key match with each other. Further, the body ECU outputs a control signal that indicates door unlocking to the door lock control unit 29 when the body ECU detects that the both codes are in a predetermined condition and the user is detected by a touch sensor or the like. In addition, the body ECU outputs a control signal indicating door locking to the door lock control unit 29 when a trigger switch instructing the lock of the door is operated by a user, the identification codes are determined to satisfy the predetermined condition.

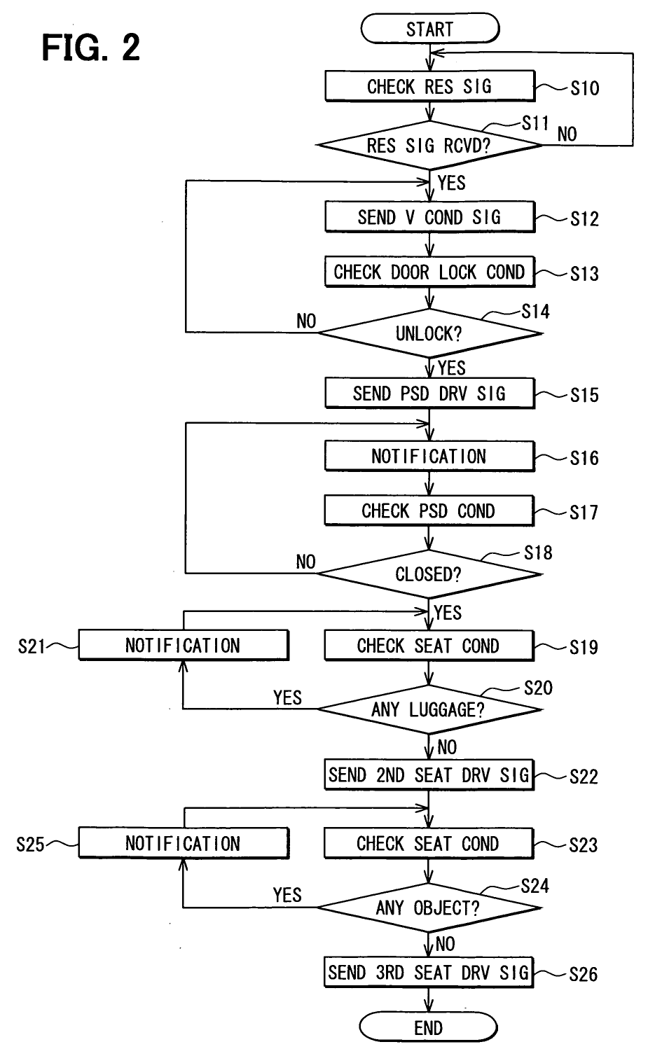

The operation of the vehicle seat control apparatus in the present embodiment is described in the following. FIG. 2 is a flowchart of the operation of the vehicle seat control apparatus in an embodiment of the present invention. While a power supply is provided for the vehicle side control unit 20, the process described in the flowchart as shown in FIG. 2 is carried out.

At first, in step S10, the ECU 21 of the vehicle side control unit 20 confirms the reception of the reservation signal from the portable unit 10 by using the vehicle side communications unit 22. Then, the ECU 21 of the vehicle side control unit 20 determines whether the reservation signal is received in step S11, and, step S12 follows when it is determined that the reservation signal has been received, and processing in step S10 is repeated when it is determined otherwise (i.e., the signal has not been received). In addition, the control unit 11 of the portable unit 10 transmits a reservation signal from the portable communication unit 12 (a built-in communication unit) when the instruction unit 13 is operated by a user.

In step S12, the ECU 21 of the vehicle side control unit 20 transmits a vehicle condition signal to the portable communication unit 12 from the vehicle side communications unit 22. The vehicle condition signal indicates that the vehicle side control unit 20 has received a reservation signal, and the second seat and the third seat cam be automatically driven. The portable unit 10 which has received the vehicle condition signal displays that the second and third seat can be automatically driven on the display unit 14. The fact that the second seat and the third seat can be automatically driven is preferably notified to the user in the above-described manner. In addition, the processing in step S12 may be skipped.

In step S13, the ECU 21 of the vehicle side control unit 20 confirms the lock/unlock condition of the door (e.g., a door of the driver's seat) by the door lock control unit 29 (a lock condition detection unit). Then, in step S14, the ECU 21 of the vehicle side control unit 20 determines whether the door is unlocked, and step S15 follows when it is determined that the door is unlocked, or processing in step S13 is repeated when it is determined that the door is unlocked (a lock condition detection unit).

In step S15, the ECU 21 of the vehicle side control unit 20 outputs a driving signal showing opening of the PSD on the left side to the PSD control unit 28 (the driving unit). In other words, the unlocking of the door is linked with the automatic opening of the PSD when a reservation signal has been received. In this manner, the PSD corresponding to the second the third seat is automatically opened, the accessibility to the third seat is further improved. In addition, the PSD may be hand-operated besides the automatic one.

In addition, in step S16, the ECU 21 of the vehicle side control unit 20 provides a vocal output of an automatic opening of the PSD from the speaker 30 (a first notification unit). The opening of the PSD can be preferably notified for a person around the vehicle in the above-described manner. In addition, step S16 may be skipped.

In step S17, the ECU 21 of the vehicle side control unit 20 confirms an opening and closing condition of the PSD by the PSD control unit 28. When the PSD is determined to be open in step S18, the ECU 21 of the vehicle side control unit 20 advances to step S19, or processing in step S16 is repeated when it is determined otherwise (i.e., the PSD is not open). In other words, the above confirmation is to determine whether the PSD is opening or closing, and the process proceeds to the next step when the PSD starts opening, or when the PSD is in a completely opening condition.

The condition of the second seat is confirmed with the seat sensor 23 and the camera 24 to determine whether the second seat can be put in a predetermined condition (i.e., whether the second seat can be moved) (a first determination unit). In other words, whether there are loads on the second seat is checked with the seat sensor 23, and whether there are loads in front of the second seat (e.g., at the foot of the second seat) or the like with the camera 24. Then, in step S20, the ECU 21 of the vehicle side control unit 20 advances to step S21 after determining that there is the loads on the second seat, or step S22 follows step S20 when it is determined that there is no load (a first determination unit).

The ECU 21 of the vehicle side control unit 20 drives the second seat so that the user can go towards the third seat in step S22. In other words, a driving signal to at least show one of folding the back of the second seat and sliding the second seat forward is output to the second seat control unit 26. The second seat control unit 26 performs either the folding of the back of the second seat or the sliding forward of the second seat upon receiving the driving signal by, for example, driving the motor or the like. In addition, whether the back of the second seat is folded or the position of the second seat is slid forward is determined by detecting the position of the second seat with the control unit 26 when the second seat is moved. Then, the second seat may be moved in the above-described manner when the back of the second seat is not folded, or when the position is not slid forward (i.e., in a front position).

In addition, the ECU 21 of the vehicle side control unit 20 may provide a vocal output (notification) from the speaker 30 (a second notification unit) when the back of the second seat is folded in the above-described manner, or the position of the second seat is slid forward. In this manner, the user can be preferably notified that the second seat is moved automatically, and the safety of the user in terms of the automatic movement of the second seat is secured.

On the other hand, in step S21, the ECU 21 of the vehicle side control unit 20 does not provide the driving signal to the second seat control unit 26 (i.e., driving control is stopped), and notifies the stop of driving of the second seat from the speaker 30 (a third notification unit). That is, for example, when there is a luggage or the like in front of or on the second seat, the second seat may not be moved because of the luggage. If the second seat is forcefully driven, the motor or the luggage may possibly be broken. Therefore, a forceful movement of the second seat is preferably prevented in the above-described manner.

In addition, a user can be preferably notified that the driving of the second seat is stopped by in the above-described manner. Further, the notification may encourage the user to remove the luggage around (the top or front) of the second seat.

The condition of the third seat is confirmed with the seat sensor 23 and the camera 24 to determine whether the third seat can be put in a predetermined condition (whether the third seat can be moved) (a second determination unit). In other words, whether there are loads on the third seat with the seat sensor 23, or with the camera 24, whether there are loads in front (at a step) of the third seat. When there are loads, the process proceeds to step S25, or the process proceeds to step S26 when there is no loads (the second determination unit).

The ECU 21 of the vehicle side control unit 20 drives the third seat so that the user can take the third seat in step S26. In other words, the ECU 21 of the vehicle side control unit 20 outputs a driving signal that indicates that the back of the third seat is put in an upright position, or indicates that the position of the third seat is moved for the sitting by the user to the third seat control unit 27. The third seat control unit 27 which has received the driving signal moves the third seat to the user sitting position, or drives the back of the seat to the upright position. In addition, whether the back of the third seat is folded, or whether the position of the third seat is suitable for sitting, is determined by the third seat control unit 27 when the third seat is moved in the above-described manner. Then, the third seat may be moved when the back is folded as described above, or when the position is not suitable for sitting.

In addition, a vocal output notifying that the third seat is driven may be provided from the speaker 30 under control of the ECU 21 of the vehicle side control unit 20 when the third seat is moved for sitting and the back of the third seat is put in the upright position (the second notification unit). The automatic movement of the third seat is preferably notified for the user in the above-described manner, for the safety of the user.

On the other hand, in step S25, the ECU 21 of the vehicle side control unit 20 does not provides the driving signal to the control unit 27 (drive control is stopped), and provides a vocal output that the driving of the third seat is stopped from the speaker 30 (a fourth notification unit). That is, for example, when there are the loads in front of or on the third seat, the third seat cannot be moved due to the loads. When the third seat is moved in such a condition forcibly, the motor or the loads may be damaged. Therefore, the third seat is prevented from being moved forcibly by the above-described manner, and the damage such as breakage of the motor of the third seat control unit 27 or the load can also be prevented.

In addition, the notification that the driving of the third seat is stopped is preferably provided in the above-described manner. Further, the user may be encouraged to move the load from the third seat when the third seat has the load put thereon or therearound.

The vehicle seat control apparatus in the present embodiment can provide an easy access to the third seat because it automatically arranges the second and third seat in a predetermined condition only by sending the reservation signal beforehand from the outside of the vehicle. For example, it is possible that the person such as a child who is not accustomed how to operate the seat may approach the third seat. In that case, the not-accustomed person may have to operate the second and the third seat, or the not-accustomed person may not easily have access to the third seat. However, as described above, the third seat can be easily accessed in the above described manner only by unlocking the door (e.g., the door of the driver's seat) because the second and the third seat are automatically put in a predetermined condition. Therefore, even the not-accustomed person can easily have access to the third seat.

What is claimed is:

1. A seat control apparatus comprising:
a controller on a vehicle that has three rows of seats; and
an instruction unit capable of communicating with the controller, wherein the instruction unit includes:
a built-in communication unit capable of communicating with the controller on the vehicle; and
an operation unit capable of being operated by a user who instructs a transmission of a reservation signal that is transmitted from an outside of the vehicle through the built-in communication unit to arrange the seats of the vehicle in a predetermined setting, and
the controller includes:
a vehicle-side communication unit capable of communicating with the built-in communication unit in the instruction unit;
a lock condition detection unit capable of detecting a lock condition of a door of the vehicle;
a driving unit capable of driving a second row and a third row of the seats of the vehicle; and
a control unit capable of controlling the driving unit to arrange the second row and the third row of the seats in the predetermined setting when a detection result of the door lock condition detected by the lock condition detection unit indicates that the door is being unlocked after receiving the reservation signal by the vehicle-side communication unit.

2. The seat control apparatus of claim 1 further comprising a door opener capable of opening a rear door that allows access to the second row and the third row of the seats of the vehicle, wherein
the door opener automatically opens the rear door in connection with an unlocking of the rear door.

3. The seat control apparatus of claim 2 further comprising a first notification unit that notifies an automatic opening of the rear door when the door opener automatically opens the rear door.

4. The seat control apparatus of claim 3, wherein
the driving unit drives a seat back of the second row of the seats in the second row in one of a folded setting and a slid-forward setting and arranges the third row of the seats in a sitting setting.

5. The seat control apparatus of claim 1 further comprising a second notification unit capable of notifying a driving of the second row and the third row of the seats when the second and the third rows of the seats are driven.

6. The seat control apparatus of claim 1 further comprising a first determination unit capable of determining whether the second row of the seats is drivable to be in the predetermined setting when the second row of the seats are automatically driven to be in the predetermined setting, wherein
the control unit stops a controlling of the driving unit to drive the second row of the seats when the first determination unit determines that the second row of the seats is not drivable.

7. The seat control apparatus of claim 6 further comprising a third notification unit capable of notifying a stopping of the driving of the second row of the seats when the driving of the second row is stopped.

8. The seat control apparatus of claim 1 further comprising a second determination unit capable of determining whether the third row of the seats is drivable to be in the predetermined setting when the third row of the seats are automatically driven to be in the predetermined setting, wherein
the control unit stops a controlling of the driving unit to drive the third row of the seats when the second determination unit determines that the third row of the seats is not drivable.

9. The seat control apparatus of claim 8 further comprising a fourth notification unit capable of notifying a stopping of the driving of the third row of the seats when the driving of the second row is stopped.
